(19) United States
(12) Patent Application Publication
(10) Pub. No.: US 2026/0218774 A1
(43) Pub. Date: Jul. 30, 2026

(54) SUPPORT ASSEMBLY

(71) Applicant: Bear Robotics, Inc., Redwood City, CA (US)

(72) Inventors: Gino NGUEGANG, Redwood City, CA (US); Ron VAN THIEL, Redwood City, CA (US); Gregory Alan WEAVER, South Jordan, UT (US); Jonathan CHANG, Redwood City, CA (US); Jinseop SIM, Redwood City, CA (US)

(73) Assignee: Bear Robotics, Inc., Redwood City, CA (US)

(21) Appl. No.: 19/144,995

(22) PCT Filed: Aug. 28, 2023
(86) PCT No.: PCT/US2023/072969

§ 371 Date: Jul. 1, 2025

Related U.S. Application Data
(60) Provisional application No. 63/436,750, filed on Jan. 3, 2023.

(51) Int. Cl. F16F 15/04; A47F 10/06; B25J 11/00

(52) U.S. Cl. CPC F16F 15/04; A47F 10/06; B25J 11/008

(57) ABSTRACT

According to one aspect of the present invention, there is provided a support assembly, comprising: a lower frame configured to be mountable on one surface of a mobile object; an upper frame positioned on top of the lower frame and configured to be movable independently of the lower frame; and a coupling unit positioned between the lower frame and the upper frame to couple the lower frame and the upper frame, wherein in response to the upper frame moving from an original position to a different position, the upper frame is configured to return to the original position by virtue of a restoring force of the coupling unit.

### CROSS-REFERENCE TO RELATED APPLICATION

This application claim the benefit of U.S. Provisional Application No. 63/436,750 filed on Jan. 3, 2023, the entire contents of which are herein incorporated by reference.

### FIELD OF THE INVENTION

The present invention relates to a support assembly.

### BACKGROUND

With the development of robot technology, service robots as well as industrial robots are attracting more attention and demand. The service robots are being applied to various fields of daily life, and among these service robots, autonomously driving serving robots for transporting food ordered by a customer to a table in a restaurant or the like are also known. The serving robots are receiving rapidly increasing attention due to their advantages of maximizing the efficiency of restaurant management and improving the quality of customer service.

FIG. 1 illustratively shows a robot for serving food and/or drinks. Referring to FIG. 1, a robot 10 comprises a drive unit 11 for moving the robot 10 and a main body unit 12 mounted on an upper end of the drive unit 11. The main body unit 12 may be provided with a device to which a user's command may be inputted or a device which may receive a user's command through wireless communication, and may autonomously drive to serve food and/or drinks to a customer or collect dishes after the customer finishes eating, according to the inputted or received command. Further, a support 13 for serving food and/or drinks or collecting dishes may be disposed on one side of the main body unit 12.

Meanwhile, impacts or vibrations may be applied to the support 13 while the robot 10 is moving due to changes in the speed of movement, direction of movement, or the like, and the impacts or vibrations may cause the food and/or drinks placed on the support 13 to spill or the dishes placed on the support 13 to fall off.

That is, the food and/or drinks or the dishes may not be stably supported on the support 13 while the robot 10 is moving, resulting in a problem that the food and/or drinks or the dishes fall off the support 13.

### SUMMARY OF THE INVENTION

One object of the present invention is to solve all the above-described problems in the prior art.

Another object of the invention is to compensate for impacts or vibrations transmitted to food and/or drinks or dishes transported by a serving robot while the serving robot is moving, so that the food and/or drinks or the dishes may be stably supported on the serving robot.

The representative configuration of the invention to achieve the above objects is described below.

According to one aspect of the invention, there is provided a support assembly, comprising: a lower frame configured to be mountable on one surface of a mobile object; an upper frame positioned on top of the lower frame and configured to be movable independently of the lower frame; and a coupling unit positioned between the lower frame and the upper frame to couple the lower frame and the upper frame, wherein in response to the upper frame moving from an original position to a different position, the upper frame is configured to return to the original position by virtue of a restoring force of the coupling unit.

In addition, there are further provided other support assemblies to implement the invention.

According to the invention, it is possible to compensate for impacts or vibrations transmitted to food and/or drinks or dishes transported by a serving robot while the serving robot is moving, so that the food and/or drinks or the dishes may be stably supported on the serving robot.

### BRIEF DESCRIPTION OF THE DRAWINGS

FIG. 1 illustratively shows a robot for serving food and/or drinks.

FIG. 2 shows a support assembly according to one embodiment of the invention.

FIG. 3 is a front view of the support assembly according to one embodiment of the invention.

FIG. 4 is an exploded front view of the support assembly according to one embodiment of the invention.

FIG. 5 is a top view of a coupling unit according to one embodiment of the invention.

FIG. 6 shows a lower frame according to one embodiment of the invention.

FIG. 7 is a bottom view of the lower frame according to one embodiment of the invention.

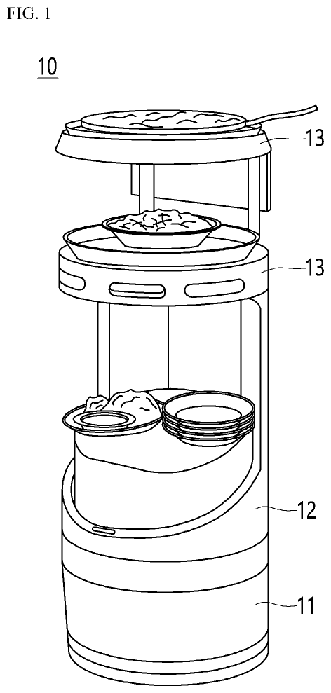

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

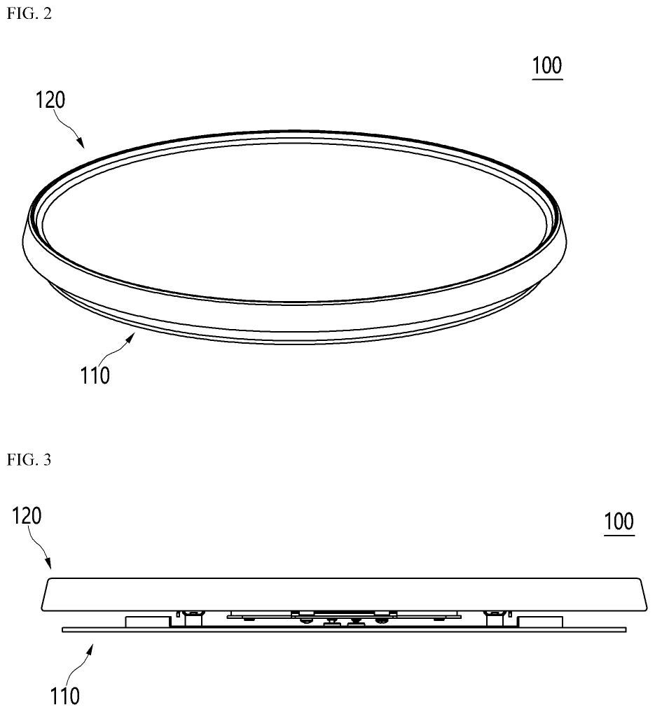

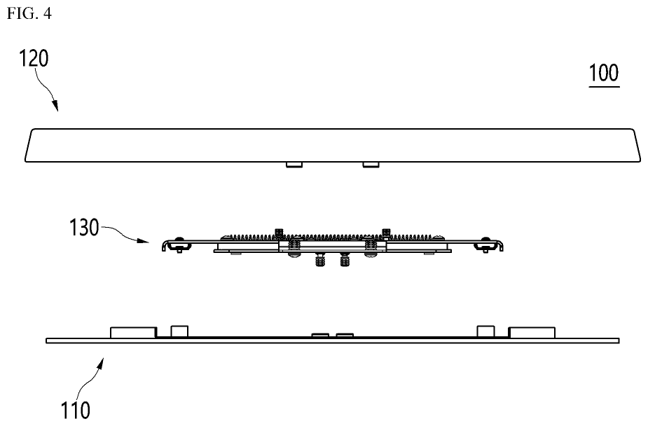

FIG. 2 shows a support assembly 100 according to one embodiment of the invention. Further, FIG. 3 is a front view of the support assembly 100 according to one embodiment of the invention.

Referring to FIGS. 2 and 3, the support assembly 100 according to one embodiment of the invention may comprise a lower frame 110 and an upper frame 120.

First, the lower frame 110 according to one embodiment of the invention may be configured to be mountable on one surface of a mobile object (not shown). Here, according to one embodiment of the invention, the mobile object may refer to an object that moves autonomously or heteronomously, and may include, for example, a robot, an automobile, and a ship.

According to one embodiment of the invention, a surface parallel to a plane on which the mobile object moves (hereinafter commonly referred to as “ground surface”) may be formed or disposed at one side of the mobile object, which will be referred to as one surface of the mobile object. For example, when the mobile object is a robot for serving food and/or drinks (i.e., a serving robot), a top surface of a support configured to support at least one object (e.g., food, drink, or tray) may correspond to the one surface of the mobile object.

According to one embodiment of the invention, the lower frame 110 may include a mechanism for allowing a bottom surface facing the one surface of the mobile object to be mounted on the mobile object. The mechanism may employ a variety of known coupling methods such as mechanical coupling and magnetic coupling. Meanwhile, the lower frame 110 may be fixedly mounted on the one surface of the mobile object, but may also be removably mounted on the one surface of the mobile object for maintenance and management.

Next, according to one embodiment of the invention, the upper frame 120 may be positioned on top of the lower frame 110, and may be configured to allow at least one object (e.g., food, drink, or tray) to rest on a top surface thereof. When the mobile object is a robot for serving food and/or drinks, the upper frame 120 may function to support the at least one object instead of the aforementioned support.

According to one embodiment of the invention, the upper frame 120 may move independently of the lower frame 110. Specifically, the upper frame 120 may maintain the same movement as the lower frame 110 (i.e., remain parallel to the ground surface) when the movement of the mobile object is stabilized (e.g., when the mobile object is not moving or is in constant velocity motion), but may have a different movement from the lower frame 110 when the movement of the mobile object is not stabilized (e.g., when the mobile object changes its direction of movement or is in accelerated motion).

More specifically, when the movement of the mobile object is not stabilized as described above, the upper frame 120 may move from an original position (i.e., a position when the movement of the mobile object is stabilized) to a different position. Such movement of the upper frame 120 may be to compensate for impacts or vibrations applied to at least one object resting on the upper frame 120. Meanwhile, the upper frame 120 may return to the original position when a predetermined amount of time elapses after the above movement.

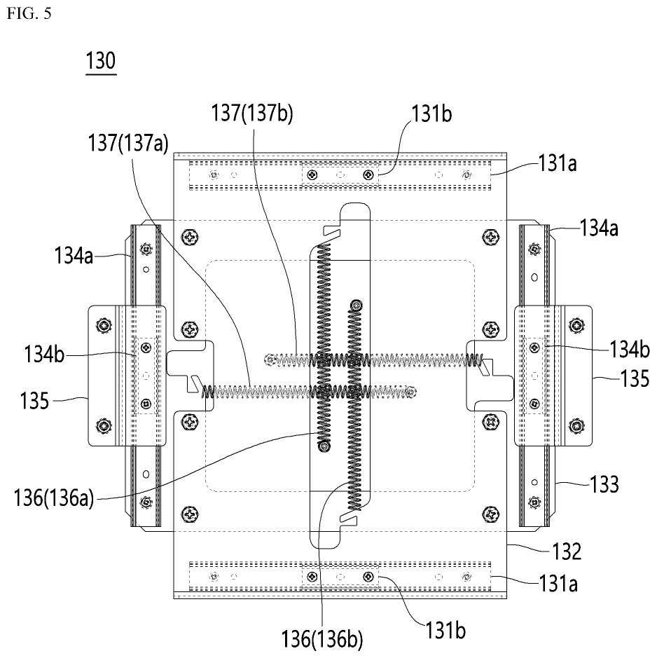

According to one embodiment of the invention, the above movement and return of the upper frame 120 may be accomplished by a coupling unit 130 positioned between the lower frame 110 and the upper frame 120, and the functions and structure of the coupling unit 130 will be described in detail with reference to FIGS. 4 and 5.

FIG. 4 is an exploded front view of the support assembly 100 according to one embodiment of the invention. Further, FIG. 5 is a top view of the coupling unit 130 according to one embodiment of the invention.

The coupling unit 130 according to one embodiment of the invention may be positioned between the lower frame 110 and the upper frame 120, and may function to couple the lower frame 110 and the upper frame 120 such that the upper frame 120 is movable with respect to the lower frame 110.

According to one embodiment of the invention, the coupling unit 130 may include various components, and the coupling structures and functions of the components are as follows:

(1) A pair of first guide rails 131a may be coupled to a top surface of the lower frame 110.

(2) A first plate 132 may be coupled to a slide member 131b positioned on each of the pair of first guide rails 131a. The slide member 131b may move along each of the pair of first guide rails 131a while coupled to the first plate 132. More specifically, the first plate 132 may be coupled to the slide member 131b to move in a direction parallel to the pair of first guide rails 131a when the movement of the mobile object is not stabilized. The movement of the first plate 132 may be made in a leftward direction or a rightward direction with respect to FIG. 5, and such movement in both directions will be collectively referred to herein as a first linear motion.

(3) A second plate 133 may be coupled to a bottom surface of the first plate 132. The second plate 133 may be basically spaced apart from the first plate 132 by a predetermined distance, but may also be closely coupled to the first plate 132 as needed.

(4) A pair of second guide rails 134a may be coupled to both ends of the second plate 133. Here, the pair of second guide rails 134a may be disposed perpendicular to the pair of first guide rails 131a.

(5) A connecting member 135 may be coupled to a slide member 134b positioned on each of the pair of second guide rails 134a. The slide member 134b may move along each of the pair of second guide rails 134a while coupled to the connecting member 135. More specifically, the connecting member 135 may be coupled to the slide member 134b to move in a direction parallel to the pair of second guide rails 134a when the movement of the mobile object is not stabilized. The movement of the connecting member 135 may be made in an upward direction or a downward direction with respect to FIG. 5, and such movement in both directions will be collectively referred to herein as a second linear motion.

(6) The connecting member 135 may be coupled to the upper frame 120 in addition to being coupled to the slide member 134b. Specifically, the connecting member 135 may be coupled to a bottom surface of the upper frame 120 such that the upper frame 120 may perform the first linear motion and/or the second linear motion when the other components perform the first linear motion and/or the second linear motion. For example, when the first plate 132 performs the first linear motion, the second plate 133 coupled to the first plate 132 may also perform the first linear motion, as well as the upper frame 120 coupled to the connecting member 135 may also perform the first linear motion. Further, when the connecting member 135 performs the second linear motion, the upper frame 120 coupled to the connecting member 135 may also perform the second linear motion. Meanwhile, it is noted that when the upper frame 120 performs the second linear motion, the first plate 132 and the second plate 133 may not perform the second linear motion together with the upper frame 120 due to their structures, and may only remain parallel to the ground surface or perform the first linear motion.

(7) The first plate 132 may include a pair of first elastic members 136 in an opening formed therein, which are disposed parallel to the pair of second guide rails 134a. Although the pair of first elastic members 136 have been described as being disposed parallel to the pair of second guide rails 134a, they may also be described as being disposed perpendicular to the pair of first guide rails 131a.

One end of each of the pair of first elastic members 136 may be coupled to the first plate 132 and the other end may be coupled to the upper frame 120. Specifically, each of the pair of first elastic members 136 may comprise a tension spring (whose spring rate may be varied as needed), and may be configured to compress or extend in opposite directions. For example, in response to the upper frame 120 performing a second linear motion in an upward direction with respect to FIG. 5, one elastic member 136a of the pair of first elastic members 136 may be extended and the other elastic member 136b may be compressed. In this case, the upper frame 120, which has performed the second linear motion in the upward direction, may return to the original position by virtue of a downward restoring force generated by the extended elastic member 136a. As another example, in response to the upper frame 120 performing a second linear motion in a downward direction with respect to FIG. 5, one elastic member 136b of the pair of first elastic members 136 may be extended and the other elastic member 136a may be compressed. In this case, the upper frame 120, which has performed the second linear motion in the downward direction, may return to the original position by virtue of an upward restoring force generated by the extended elastic member 136b.

(8) The second plate 133 may include a pair of second elastic members 137 in an opening formed therein, which are disposed parallel to the pair of first guide rails 131a. Although the pair of second elastic members 137 have been described as being disposed parallel to the pair of first guide rails 131a, they may also be described as being disposed perpendicular to the pair of second guide rails 134a.

One end of each of the pair of second elastic members 137 may be coupled to the second plate 133 and the other end may be coupled to the lower frame 110. Specifically, each of the pair of second elastic members 137 may comprise a tension spring (whose tension spring may be varied as needed), and may be configured to compress or extend in opposite directions. For example, in response to the upper frame 120 performing a first linear motion in a leftward direction with respect to FIG. 5, one elastic member 137a of the pair of second elastic members 137 may be extended and the other elastic member 137b may be compressed. In this case, the upper frame 120, which has performed the first linear motion in the leftward direction, may return to the original position by virtue of a rightward restoring force generated by the extended elastic member 137a. As another example, in response to the upper frame 120 performing a first linear motion in a rightward direction with respect to FIG. 5, one elastic member 137b of the pair of second elastic members 137 may be extended and the other elastic member 137a may be compressed. In this case, the upper frame 120, which has performed the first linear motion in the rightward direction, may return to the original position by virtue of a leftward restoring force generated by the extended elastic member 137b.

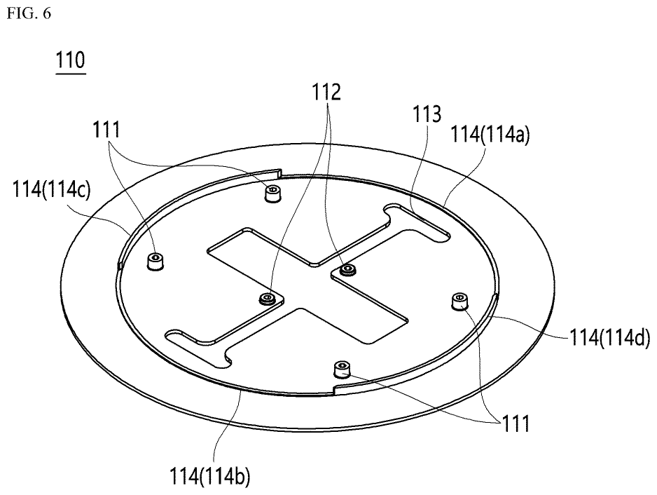

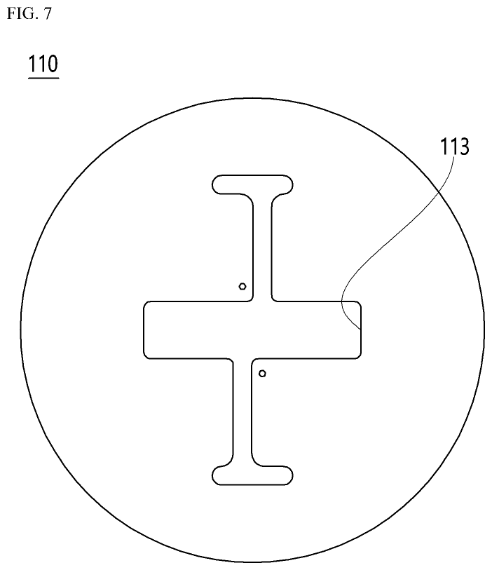

The components included in the coupling unit 130 have been described as above, and the lower frame 110 will be further described below with reference to FIGS. 6 and 7.

FIG. 6 shows the lower frame 110 according to one embodiment of the invention. Further, FIG. 7 is a bottom view of the lower frame 110 according to one embodiment of the invention.

The lower frame 110 according to one embodiment of the invention may include a first mounting unit 111 for allowing the pair of first guide rails 131a to be coupled to the lower frame 110, and a second mounting unit 112 for allowing the pair of second elastic members 137 to be coupled to the lower frame 110.

Further, the lower frame 110 according to one embodiment of the invention may include an opening 113 therein, which is formed in a predetermined shape. According to one embodiment of the invention, the opening 113 may be formed to facilitate assembling the components of the coupling unit 130 (e.g., the pair of first elastic members 136 and the pair of second elastic members 137) in the course of assembly of the support assembly 100, or to facilitate replacing the components of the coupling unit 130 after completion of the assembly of the support assembly 100. According to one embodiment of the invention, the opening 113 may be formed in a shape similar to a cross, but is not necessarily limited thereto and may be changed to various shapes to the extent consistent with the uses described above.

Further, the lower frame 110 according to one embodiment of the invention may include a protrusion 114 formed in a shape that surrounds all the first mounting unit 111, the second mounting unit 112, and the opening 113. According to one embodiment of the invention, it may be understood that the shape of the protrusion 114 is intended to surround the coupling unit 130 as the assembly of the support assembly 100 is completed.

According to one embodiment of the invention, the protrusion 114 may be formed to have a predetermined height to prevent foreign matter such as liquid from entering the interior of the support assembly 100 (or the coupling unit 130).

According to one embodiment of the invention, at least two parts 114a, 114b of the protrusion 114 may have a relatively smaller height than the other parts 114c, 114d, which may be intended to prevent the components of the coupling unit 130 that perform a first linear motion together with the upper frame 120 from impinging on the protrusion 114 while the upper frame 120 performs the first linear motion.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A support assembly, comprising:
a lower frame configured to be mountable on one surface of a mobile object;
an upper frame positioned on top of the lower frame and configured to be movable independently of the lower frame; and
a coupling unit positioned between the lower frame and the upper frame to couple the lower frame and the upper frame,
wherein in response to the upper frame moving from an original position to a different position, the upper frame is configured to return to the original position by virtue of a restoring force of the coupling unit.

2. The support assembly of claim 1, wherein the coupling unit comprises:
a pair of first guide rails coupled to a top surface of the lower frame;
a first plate coupled to a slide member moving along each of the pair of first guide rails to perform a first linear motion in a direction parallel to the pair of first guide rails;
a second plate coupled to a bottom surface of the first plate;
a pair of second guide rails coupled to both ends of the second plate and disposed perpendicular to the pair of first guide rails; and
a connecting member coupled to a slide member moving along each of the pair of second guide rails to perform a second linear motion in a direction parallel to the pair of second guide rails, and coupled to the upper frame.

3. The support assembly of claim 2, wherein in response to the first plate performing the first linear motion, the second plate and the upper frame perform the first linear motion.

4. The support assembly of claim 2, wherein in response to the connecting member performing the second linear motion, the first plate and the second plate do not perform the second linear motion and the upper frame performs the second linear motion.

5. The support assembly of claim 2, wherein the first plate includes a pair of first elastic members in an opening formed therein, which are disposed parallel to the pair of second guide rails, and
wherein one end of each of the pair of first elastic members is coupled to the first plate and the other end is coupled to the upper frame, and the pair of first elastic members are configured to compress or extend in opposite directions to return the upper frame to the original position in response to the upper frame performing the second linear motion.

6. The support assembly of claim 2, wherein the second plate includes a pair of second elastic members in an opening formed therein, which are disposed parallel to the pair of first guide rails, and
wherein one end of each of the pair of second elastic members is coupled to the second plate and the other end is coupled to the lower frame, and the pair of second elastic members are configured to compress or extend in opposite directions to return the upper frame to the original position in response to the upper frame performing the first linear motion.
